(19) United States
(12) Patent Application Publication
(10) Pub. No.: US 2024/0115011 A1
(43) Pub. Date: Apr. 11, 2024

(54) Shoe Pattern Imprinting Mechanism and Imprinting Method Thereof

(71) Applicant: DAH LIH PUH CO., LTD., Taichung City (TW)

(72) Inventor: Jui-Fen Shiao, Taichung City (TW)

(21) Appl. No.: 17/938,879

(22) Filed: Oct. 7, 2022

(51) Int. Cl. A43D 95/14; B32B 37/00; B32B 37/06; B32B 37/10; B32B 38/18

(52) U.S. Cl. CPC A43D 95/14; B32B 37/0046; B32B 37/025; B32B 37/06; B32B 37/10; B32B 38/1858; B32B 2309/02; B32B 2309/12; B32B 2437/02

(57) ABSTRACT

A shoe pattern imprinting mechanism, provided to cooperate with an imprinting film, the shoe pattern imprinting mechanism comprising: a main body; a driving mechanism installed on the main body and having a driving shaft configured to move forward and backward; a flexible pressing ball made of a flexible material, installed on the driving shaft and having a plurality of vent holes thereon; a suction mechanism fluidly connected to the vent holes of the flexible pressing ball to perform suction; a carrier stand installed on the main body and provided to carry a shoe body thereon, thereby when the carrier stand and the flexible pressing ball being separated by a distance, a heating space being formed between the carrier stand and the flexible pressing ball; a heating unit installed on the main body to move forward and backward, the heating unit configured to move into and away from the heating space.

### BACKGROUND OF THE INVENTION

### 1. Technical Field

The present invention is related to a processing mechanism for shoe parts, and in particular, to a shoe pattern imprinting mechanism.

In addition, the present invention is further related to an imprinting method for the aforementioned shoe pattern imprinting mechanism.

### 2. Description of Related Art

To allow shoe surfaces to have specific pattern in order to increase the visual effect of the shoe appearance, shoe surfaces are typically imprinted with color imprinting films, as shown in FIGS. 1A and 1B. According to a known imprinting procedure, an imprinting film K is laid on a predefined position of a shoe body J. The aforementioned predefined position can be a side surface of the shoe body J, and the aforementioned imprinting film K includes a hot melt layer K1, an imprinting layer K2 and a release layer K3 stacked thereon sequentially. The hot melt layer K1 is disposed closer to the shoe body J in comparison to the imprinting layer K2 and the release layer K3, and the hot melt layer K1 is also attached to the shoe body J. The release layer K3 is disposed away from the shoe body J in comparison to the imprinting layer K2 and the hot melt layer K1. Furthermore, an external heat source N is used to heat the imprinting film K, in order to allow the hot melt layer K1 to reach the melting state, such that the pattern of the imprinting film K can be imprinted onto the shoe body J.

During heating, the heat source N is positioned at one side closest to the release layer K3 and away from the hot melt layer K1. Since the imprinting layer K2 is located between the hot melt layer K1 and the release layer K3, the heating effect of the heat source N on the imprinting layer K2 is greater than the hot melt layer K1, such that when the hot melt layer K1 reaches the melting state temperature, the imprinting layer K2 may be damaged due to the overly high temperature.

Furthermore, to allow the hot melt layer K1 attached to the shoe body J to reach the melting state, the temperature of the heat source N needs to be maintained at a higher level. If the shoe body J is unable to withstand the aforementioned high temperature, it may also be damaged. Accordingly, there is a need for a mechanism capable for preventing damages of the imprinting layer K2 and the shoe body J due to high temperature and allowing automated operation.

### BRIEF SUMMARY OF THE INVENTION

The present invention provides a shoe pattern imprinting mechanism, and its main objective is to prevent damage of the imprinting layer due to high temperature.

Another objective of the present invention is to provide a shoe pattern imprinting mechanism capable of preventing damage of the shoe body due to high temperature.

Still another objective of the present invention is to provide a shoe pattern imprinting mechanism allowing automated operation.

To achieve the aforementioned objectives, the present invention discloses a shoe pattern imprinting mechanism, provided to cooperate with an imprinting film, the imprinting film having a hot melt layer, an imprinting layer and a release layer stacked on each other sequentially, the shoe pattern imprinting mechanism comprising:
A main body;
A driving mechanism installed on the main body and having a driving shaft, the driving shaft configured to move forward and backward;
A flexible pressing ball installed on the driving shaft and having a plurality of vent holes formed thereon, the flexible pressing ball being made of a flexible material;
A suction mechanism fluidly connected to the plurality of vent holes of the flexible pressing ball and provided to perform suction;
A carrier stand installed on the main body and provided to carry a shoe body thereon, thereby when the carrier stand and the flexible pressing ball being separated by a distance, a heating space being formed between the carrier stand and the flexible pressing ball;
A heating unit moveably installed on the main body to move forward and backward, the heating unit configured to move to the heating space or to move away from the heating space.

In addition, the present invention further discloses an imprinting method for the shoe pattern imprinting mechanism, comprising:
A film obtaining step, actuating the driving mechanism to allow the driving shaft to drive the flexible pressing ball to approach the imprinting film, the flexible pressing ball contacting the imprinting film, and actuating the suction mechanism to perform suction with the plurality of vent holes sucking the imprinting film;
A moving step, actuating the driving mechanism to allow the driving shaft to drive the flexible pressing ball and the imprinting film to move away from the carrier stand and the shoe body, forming a heating space between the carrier stand and the flexible pressing ball;
A heating step, actuating the heating unit to move to the heating space, the heating unit facing toward the flexible pressing ball and the imprinting film, the imprinting layer arranged further away from the heating unit in comparison to the hot melt layer, the heating unit heating the imprinting film until the hot melt layer reaching a molten state;
A retreat step, actuating the heating unit to move away from the heating space; an imprinting step, actuating the driving shaft to drive the flexible pressing ball and the imprinting film to approach the shoe body until the imprinting film being attached to the shoe body, the imprinting film being imprinted onto a surface of the shoe body;
A release step, removing the release film.

Preferably, the heating unit includes a first heater and a second heater. The first heater heats the imprinting film, and the second heater heats the shoe body.

Accordingly, the flexible pressing ball includes the plurality of vent holes, and the plurality of vent holes are fluidly connected to the suction mechanism, allowing the flexible pressing ball to suck or release the imprinting film, such that the imprinting film can be driven to move away from the shoe body, and a heat space is formed between the shoe body and the imprinting film. As a result, when the heating unit moves to the heating space, the imprinting layer of the imprinting film is further away from the heating unit in comparison to the hot melt layer, such that the heat received by the imprinting layer is less than the heat received by the hot melt layer, thereby effectively preventing damage of the imprinting layer due to overly high temperature.

Furthermore, since the first heater is installed on the upper surface of the heating unit and the second heater is installed on the lower surface of the heating unit, and the first heater and the second heater can be adjusted for different temperatures respectively, accordingly, the conditions of deterioration and damage of the shoe body due to overly high temperature can be prevented.

### BRIEF DESCRIPTION OF THE SEVERAL VIEWS OF THE DRAWINGS

FIG. 1A is a schematic view of a known imprinting structure;

FIG. 1B is an enlarged partial view of the known imprinting structure;

FIG. 2 is a perspective view of a shoe pattern imprinting mechanism of the present invention;

FIG. 3 is an exploded partial view of the shoe pattern imprinting mechanism of the present invention;

FIG. 4 is a front view of the shoe pattern imprinting mechanism of the present invention;

FIG. 5 is a schematic view illustrating the imprinting film being laid on the shoe body;

FIG. 6 is a schematic view illustrating an operation of the shoe pattern imprinting mechanism of the present invention;

FIG. 7 is a schematic view illustrating an operation of the shoe pattern imprinting mechanism of the present invention;

FIG. 8 is a schematic view illustrating an operation of the shoe pattern imprinting mechanism of the present invention;

FIG. 9 is a schematic view illustrating an operation of the shoe pattern imprinting mechanism of the present invention;

FIG. 10 is another schematic view illustrating an operation of the shoe pattern imprinting mechanism of the present invention;

FIG. 11 is a schematic view illustrating the imprinting film being imprinted on the shoe body; and

FIG. 12 is a flow chart of an imprinting method of the shoe pattern imprinting mechanism of the present invention.

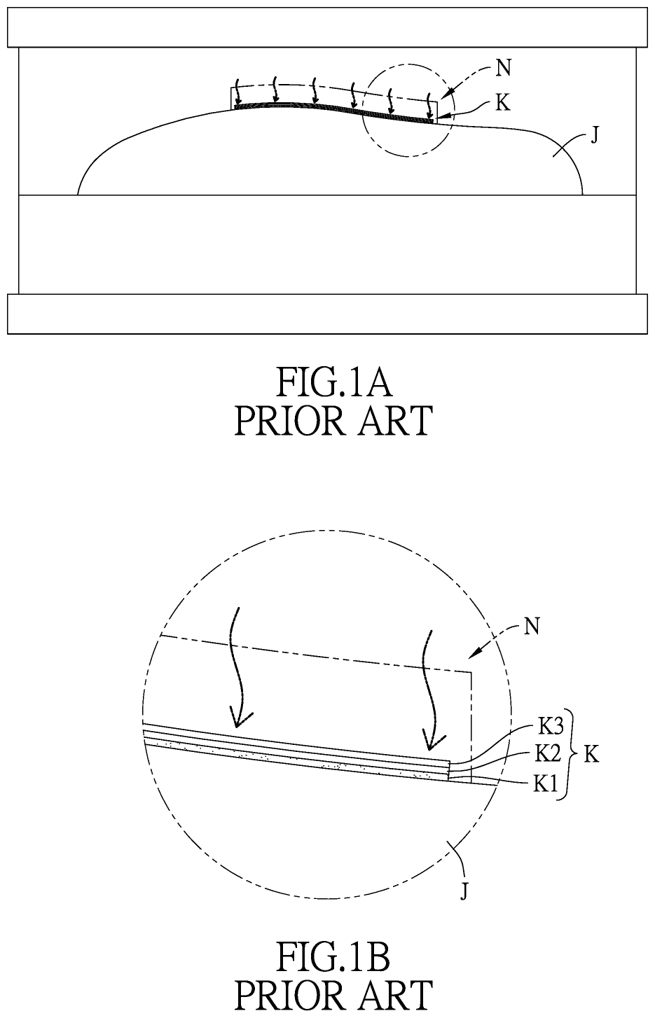

### DETAILED DESCRIPTION OF THE INVENTION

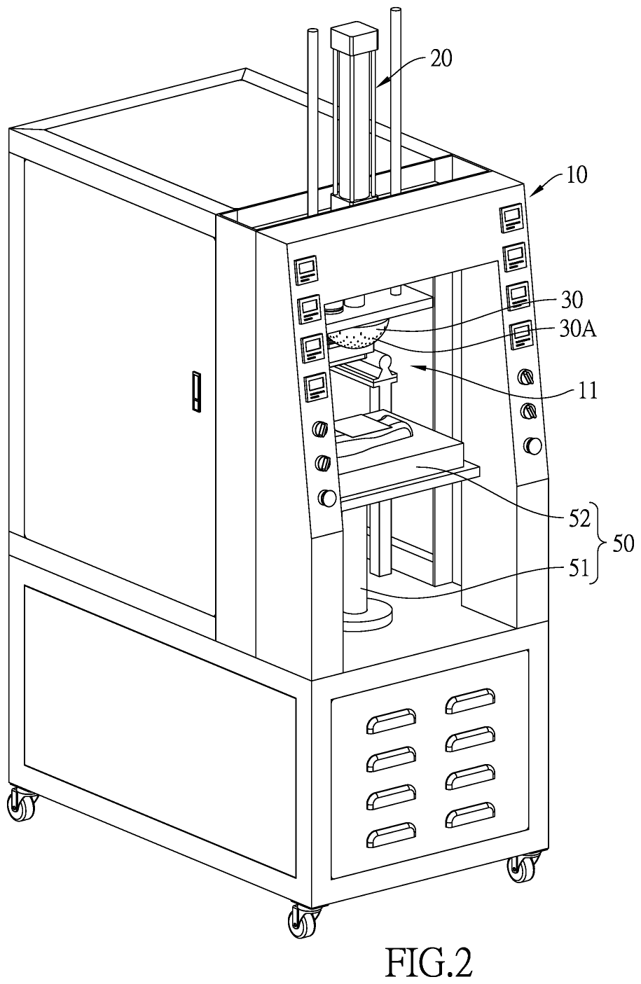

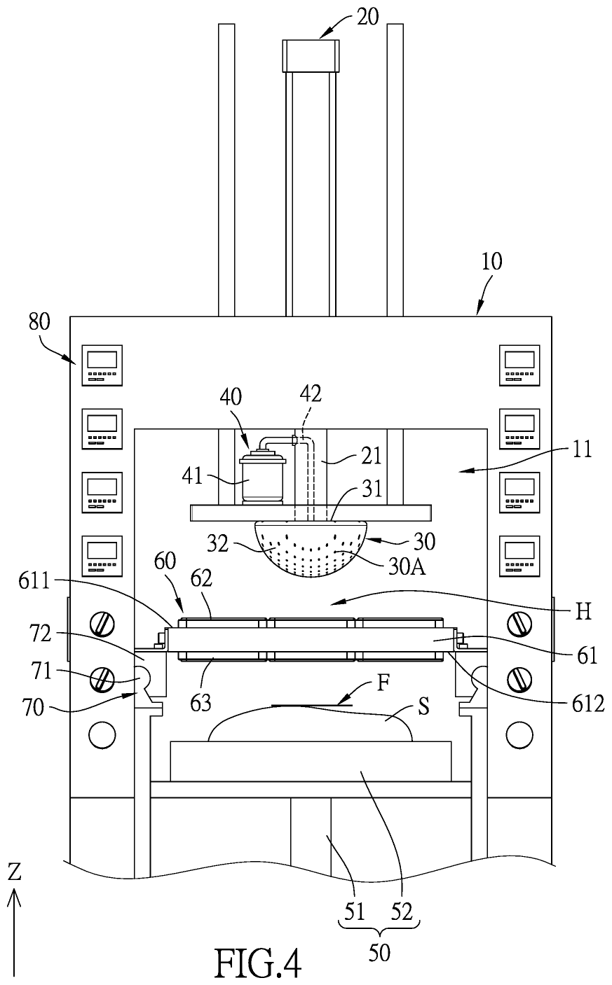

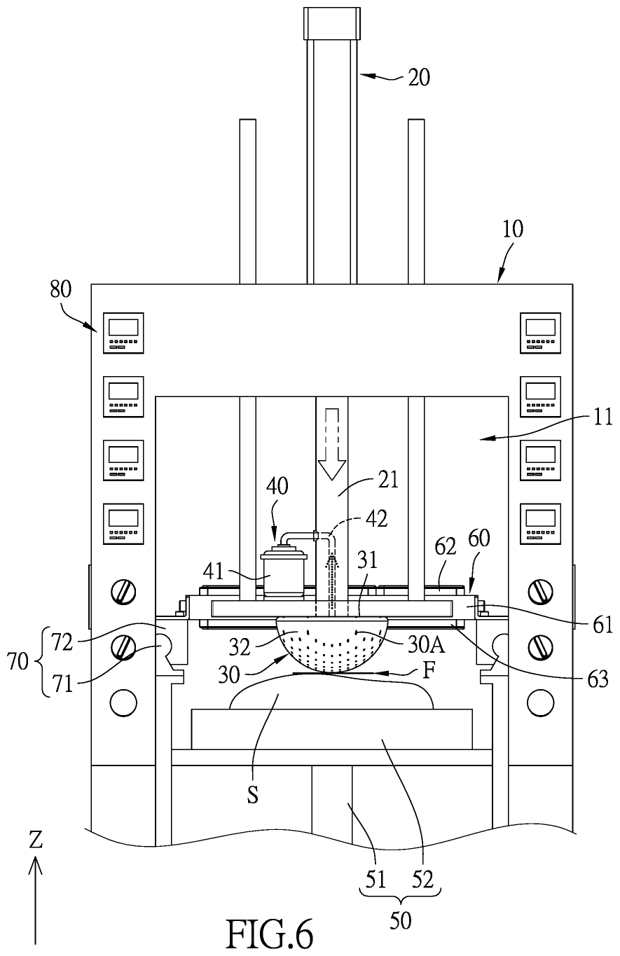

The present invention provides a shoe pattern imprinting mechanism, provided to cooperate with an imprinting film F. The imprinting film F includes a hot melt layer F1, an imprinting layer F2 and a release layer F3 stacked on each other sequentially. The melting temperature of the hot melt layer F1 can be between 50° C. and 110° C. The material of the release layer F3 can use polyethylene terphthalates (PET), polyethylene (PE), polyvinyl chloride (PVC), polypropylene (PP), or paper; however, the present invention is not limited to such materials only. The material of the imprinting layer F2 can use thermoplastic polyurethane (TPU), polyurethane (PU), rubber, heat press ink, oil-based ink, color ink, or white ink; however, the present invention is not limited to such material only. As shown in FIG. 2 to FIG. 11, the shoe pattern imprinting mechanism comprises:
A main body 10 having a receiving space 11;
A driving mechanism 20 installed on the main body 10, the driving mechanism having a driving shaft 21, the driving shaft 21 configured to move forward and backward along a vertical direction Z; in this embodiment, the driving mechanism 21 is a pneumatic cylinder or hydraulic cylinder;
A flexible pressing ball 30 installed on the driving shaft 21, allowing the flexible pressing ball 30 to move together with the driving shaft 21 and along the vertical direction Z; the flexible pressing ball 30 having a flat surface 31 and a curved surface 32, the driving shaft 21 connected to the flat surface 31, the curved surface 32 provided to contact the imprinting film F; the flexible pressing ball 30 having a plurality of vent holes 30A formed on the curved surface 32; the flexible pressing ball 30 being made of a flexible material such that the flexible pressing ball 30 can be slightly deformed, and a hardness of the flexible pressing ball can be between the shore hardness of 10 A-60 A, and a distribution density of the plurality of vent holes 30A can be one vent hole 30A for each square centimeter (cm2). In this embodiment, the material of the flexible pressing ball 30 is silicone; however, the present invention is not limited to such type only;
A suction mechanism 40 fluidly connected to the plurality of vent holes 30A of the flexible pressing ball 30, the suction mechanism 40 provided to suck air in order to generate a low pressure at the surrounding of the plurality of vent holes 30A, and to allow the plurality of vent holes 30A to suck the imprinting film F, thereby allowing the imprinting film F to be attached to the flexible pressing ball 30 and to move together with the flexible pressing ball 30; in addition, when the suction mechanism 40 stops sucking air, the imprinting film F can be released. In this embodiment, the suction mechanism 40 includes a suction unit 41 and a suction tube 42 fluidly connected to the suction unit 41; the suction tube 42 is fluidly connected to the driving shaft 21, and the driving shaft 21 has a hollow column shape; the driving shaft 21 is fluidly connected to the plurality of vent holes 30A, such that when the suction mechanism 40 sucks air, it is able to generate a low pressure at the surrounding of the plurality of vent holes 30A;
A carrier stand 50 installed on the main body 10; the carrier stand 50 having a column 51 and a carrying platform 52; the column 51 connected to one side of the carrying platform 52, and another side of the carrying platform 52 provided to carry a shoe body S thereon; the carrying platform 52 facing toward the flexible pressing ball 30, the carrying platform 52 and the flexible pressing ball 30 separated from each other by a distance, thereby defining a heating space H between the carrying platform 52 and the flexible pressing ball 30;
A heating unit 60 moveably installed on the main body 10 to move forward and backward along a horizontal direction Y; the horizontal direction Y being perpendicular to the vertical direction Z, such that the heating unit 60 is able to move to the heating space H or move away from the heating space H; the heating unit 60 provided to heat the imprinting film F and the shoe body S.

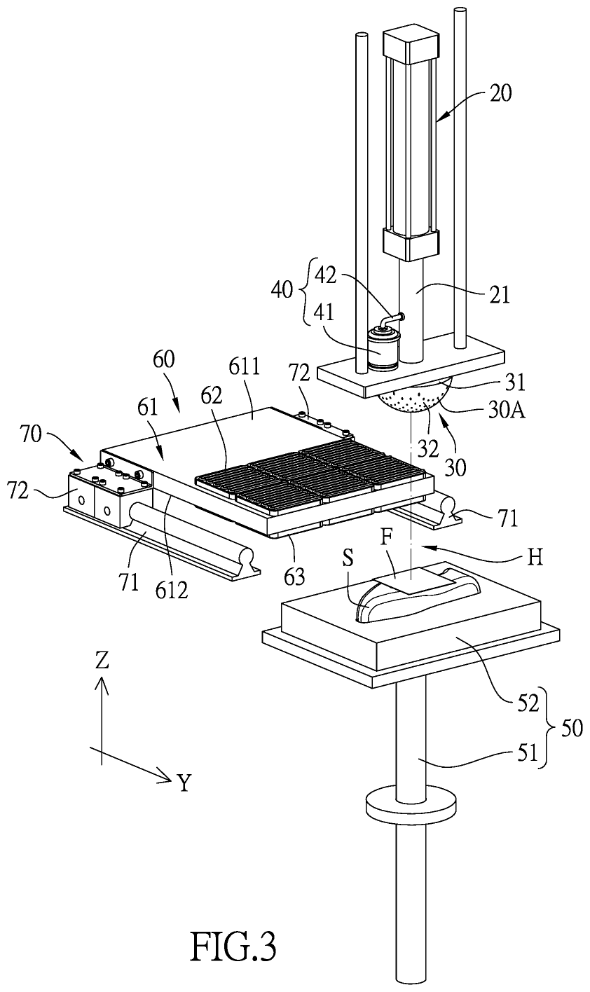

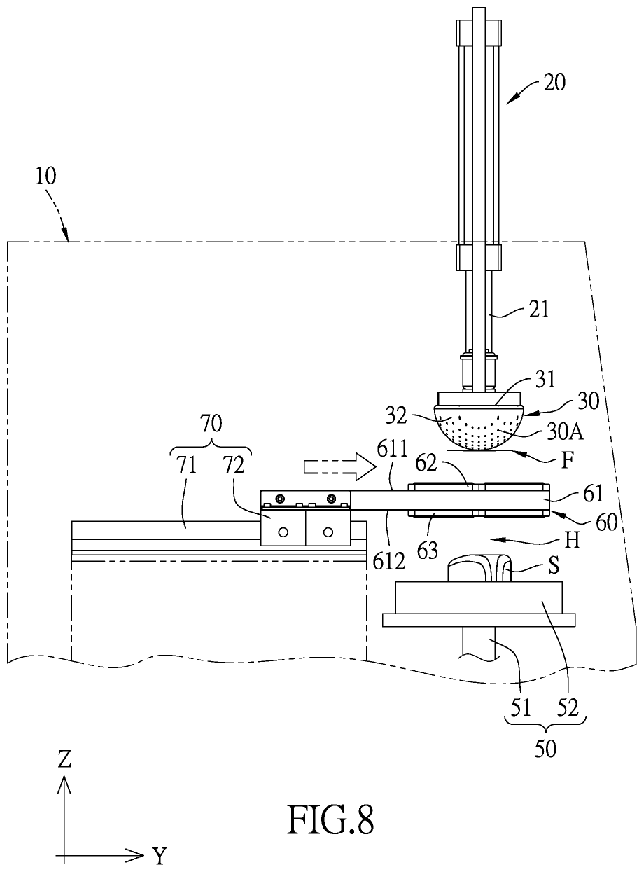

In this embodiment, as shown in FIG. 3, the heating unit 60 includes a moving plate 61, and the moving plate 61 is a rectangular plate. The moving plate 61 includes an upper surface 611 and a lower surface 612 opposite from each other arranged along the vertical direction Z. The upper surface 611 includes a first heater 62 installed thereon, and the lower surface 612 includes a second heater 63 installed thereon. The first heater 62 and the second heater 63 are a plurality of heating coils respectively. When the heating unit 60 moves to the heating space H, as shown in FIG. 8, the first heater 62 faces toward the flexible pressing ball 30 and the imprinting film F, and the second heater 63 faces toward the carrier stand 50 and the shoe body S.

As shown in FIG. 3, it further includes a moving mechanism 70 attached to the heating unit 60. The moving mechanism 70 is provided to drive the heating unit 60 to move forward and backward along the horizontal direction Y. The moving mechanism 70 includes two sliding rails 71 and two sliders 72. The two sliding rails 71 are arranged at two opposite sides of the moving plate 61 respectively and secured and attached to the main body 10. The two sliders 72 are installed on the two sliding rails 71 respectively. The two sliders 72 are fastened at two opposite sides of the moving plate 61 respectively, in order to allow the moving plate 61 to move together with the two sliders 72.

Preferably, it further includes a control unit 80 connected to the moving mechanism 70, the driving mechanism 20 and the suction mechanism 40 for controls thereof. The control unit 80 is provided to control movements of the sliders 72 of the moving mechanism 70 and the driving shaft 21 of the driving mechanism 20. The control unit 80 further controls the suction or stop of suction of the suction mechanism 40.

Preferably, the control unit 80 is connected to the first heater 62 and the second heater 63 for controls thereof. The control unit 80 is provided to control the temperature of the first heater 62 and the second heater 63 respectively, in order to maintain the first heater 62 and the second heater 63 to be at the same temperature or different temperatures. In this embodiment, the temperature of the first heater 62 heating the imprinting film F is between 80° C. and 120° C., and the temperature of the second heater 63 heating the shoe body S is between 50° C. and 80° C.

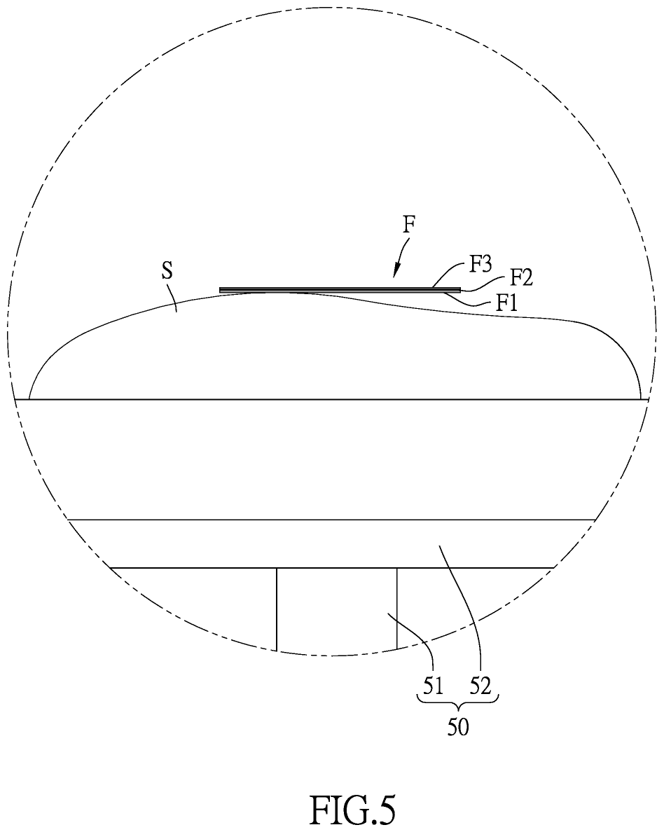

In addition, the present invention further provides an imprinting method for the shoe pattern imprinting mechanism, as shown in FIGS. 5 to 12, comprising:

A film obtaining step A1, as shown in FIGS. 5, 6 and 12, actuating the driving mechanism 20 to allow the driving shaft 21 to drive the flexible pressing ball 30 to approach the imprinting film F, the flexible pressing ball 30 contacting the imprinting film F, and actuating the suction mechanism 40 to perform suction in order to generate a low pressure at the surrounding of the plurality of vent holes 30A, and the plurality of vent holes 30A sucking the imprinting film F. In this embodiment, the initial position of the imprinting film F is located on top of the shoe body S, and the shoe body S is arranged on the carrier platform 52;

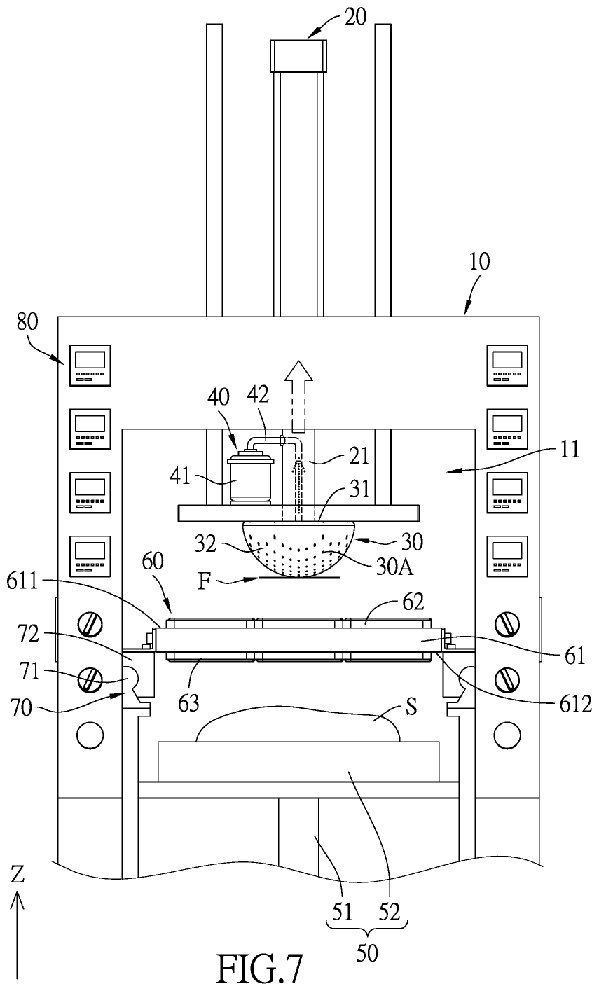

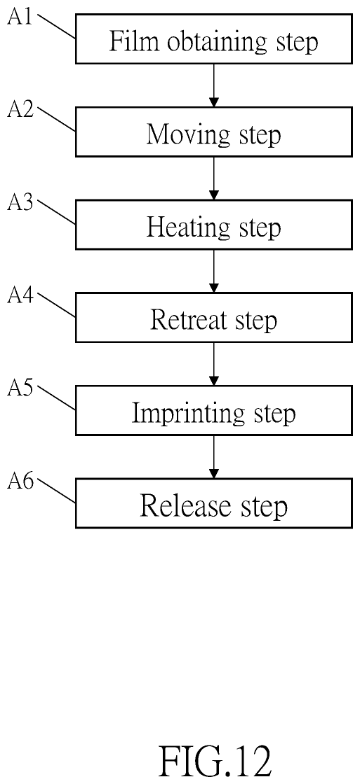

A moving step A2, as shown in FIGS. 7 and 12, actuating the driving mechanism 20 to allow the driving shaft 21 to drive the flexible pressing ball 30 and the imprinting film F to move away from the carrier stand 50 and the shoe body S, forming a heating space H between the carrier stand 52 and the flexible pressing ball 30;

A heating step A3, as shown in FIGS. 8 and 12, driving the heating unit 60 to move to the heating space H, allowing the first heater 62 to face toward the flexible pressing ball 30 and the imprinting film F, and allowing the second heater 63 to face toward the carrier stand 50 and the shoe body S. At this time, the hot melt layer F1 of the imprinting film F is at the position closest to the first heater 62, the imprinting layer F2 is further away from the first heater 62 in comparison to the hot melt layer F1, and the release layer F3 of the imprinting film F is at the position furthest from the first heater 62. The first heater 62 heats the imprinting film F until the hot melt layer F1 becomes the molten state. In addition, the second heater 63 heats the shoe body S. In this embodiment, the temperature of the first heater 62 heating the imprinting film F is between 80° C. and 120° C., and the temperature of the second heater 63 heating the shoe body S is between 50° C. and 80° C. The heating time of the first heater 62 and the second heater 63 is greater than or equal to 5 minutes and smaller than or equal to 30 minutes respectively;

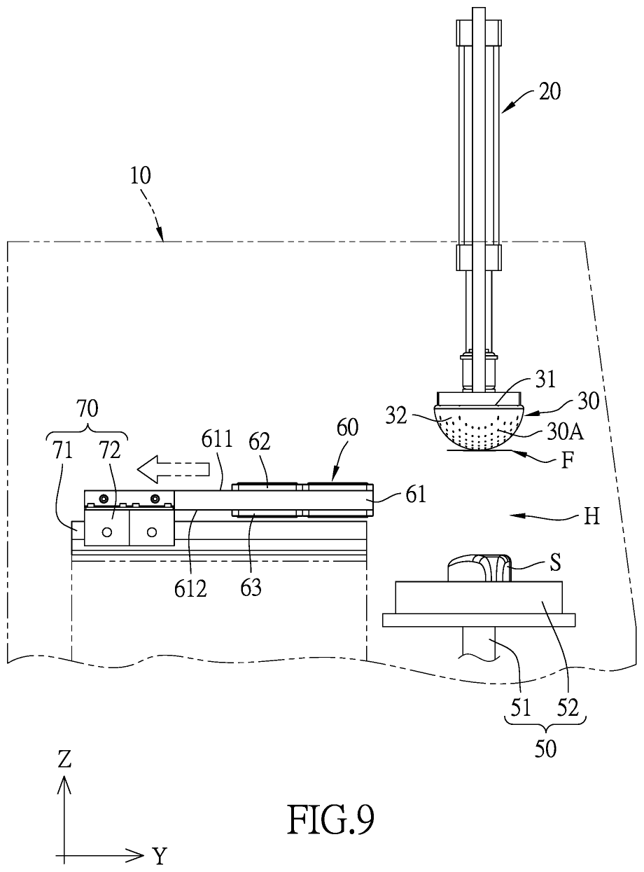

A retreat step A4, as shown in FIGS. 9 and 12, actuating the heating unit 60 to move away from the heating space H;

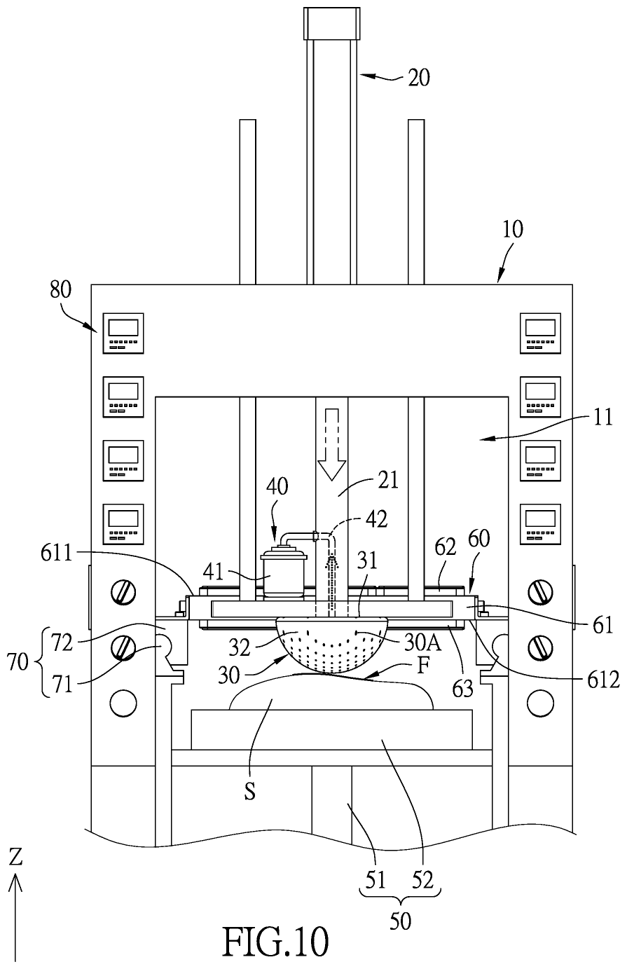

An imprinting step A5, as shown in FIGS. 10 and 12, actuating the driving mechanism 20 to allow the driving shaft 21 to drive the flexible pressing ball 30 and the imprinting film F to approach the shoe body S until the imprinting film F is attached to the surface of the shoe body S. At this time, since the hot melt layer F1 of the imprinting film F is under the molten state, the imprinting film F can be imprinted to the surface of the shoe body S. In this embodiment, the pressure of the flexible pressing ball 30 pressing the imprinting film F on the shoe body S is greater than or equal to 0.1 kPa and smaller than or equal to 15 kPa, and the pressing time of the flexible pressing ball 30 pressing the imprinting film F on the shoe body S is greater than or equal to 5 minutes or smaller than or equal to 60 minutes.

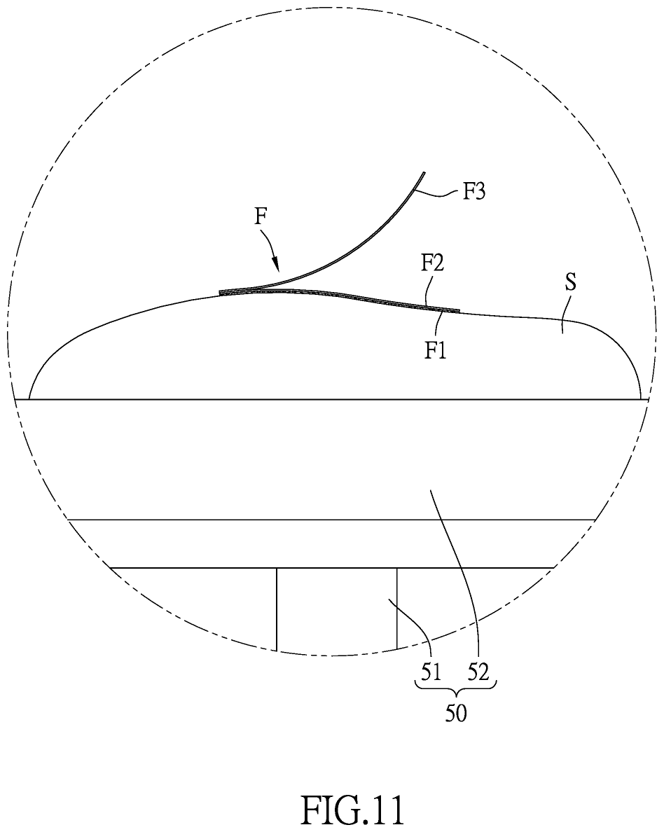

A release step A6, as shown in FIGS. 11 and 12, removing the release film F3 to complete the imprinting process. In this embodiment, the suction mechanism 40 is actuated to perform suction and the driving mechanism 20 is actuated to move away from the shoe body S, allowing the release film F3 to be driven and removed by the flexible pressing ball 30.

The above provides description of the structural configurations of main components and imprinting method of exemplary embodiments of the present invention. The technical effects of the present invention are further explained in the following.

The present invention mainly utilizes the flexible pressing ball 30 having the plurality of vent holes 30A, and the plurality of vent holes 30A are fluidly connected to the suction mechanism 40, allowing the flexible pressing ball 30 to suck or release the imprinting film F, such that the imprinting film F can be driven to move away from the shoe body S, and a heat space H is formed between the shoe body S and the imprinting film F. As a result, when the heating unit 60 moves to the heating space H, the imprinting layer F2 of the imprinting film F is further away from the heating unit 60 in comparison to the hot melt layer F1, such that the heat received by the imprinting layer F2 is less than the heat received by the hot melt layer F1, thereby effectively preventing damage of the imprinting layer F2 due to overly high temperature.

Furthermore, since the first heater 62 is installed on the upper surface 611 of the heating unit 60 and the second heater 63 is installed on the lower surface 612 of the heating unit 60, and the first heater 62 and the second heater 63 can be adjusted for different temperatures respectively, accordingly, the conditions of deterioration and damage of the shoe body S due to overly high temperature can be prevented.

What is claimed is:

1. A shoe pattern imprinting mechanism, provided to cooperate with an imprinting film, the shoe pattern imprinting mechanism comprising:
a main body;
a driving mechanism installed on the main body and having a driving shaft, the driving shaft configured to move forward and backward;
a flexible pressing ball installed on the driving shaft and having a plurality of vent holes formed thereon, the flexible pressing ball being made of a flexible material;
a suction mechanism fluidly connected to the plurality of vent holes of the flexible pressing ball and provided to perform suction;
a carrier stand installed on the main body and provided to carry a shoe body thereon, thereby when the carrier stand and the flexible pressing ball being separated by a distance, a heating space being formed between the carrier stand and the flexible pressing ball; and
a heating unit moveably installed on the main body to move forward and backward, the heating unit configured to move to the heating space or to move away from the heating space.

2. The shoe pattern imprinting mechanism according to claim 1, wherein the flexible pressing ball includes a flat surface and a curved surface, the driving shaft is connected to the flat surface, the curved surface is provided to contact the imprinting film, and the plurality of vent holes are located on top of the curved surface.

3. The shoe pattern imprinting mechanism according to claim 1, wherein the suction mechanism includes a suction unit and a suction tube fluidly connected to the suction unit, the suction tube is fluidly connected to the driving shaft, the driving shaft is hollow, and the driving shaft is fluidly connected to the plurality of vent holes.

4. The shoe pattern imprinting mechanism according to claim 1, wherein the carrier stand includes a column and a carrying platform, the column is connected to one side of the carrying platform, and another side of the carrying platform is provided to carry the shoe body, and the carrying platform faces toward the flexible pressing ball.

5. The shoe pattern imprinting mechanism according to claim 1, wherein the driving shaft is configured to move forward and backward along a vertical direction, the heating unit is configured to move forward and backward in a horizontal direction, and the horizontal direction is perpendicular to the vertical direction.

6. The shoe pattern imprinting mechanism according to claim 1, wherein the heating unit includes a moving plate, the moving plate includes an upper surface and a lower surface opposite from each other, the upper surface includes a first heater installed thereon, the lower surface includes a second heater installed thereon, thereby when the heating unit is positioned at the heating space, the first heater faces toward the flexible pressing ball, and the second heater faces toward the carrier stand.

7. The shoe pattern imprinting mechanism according to claim 6, further comprising a moving mechanism attached to the heating unit, the moving mechanism is provided to drive the heating unit to move, the moving mechanism includes two sliding rails and two sliders, the two sliding rails are arranged at two opposite sides of the moving plate respectively and are secured and attached to the main body, the two sliders are installed on the two sliding rails respectively, and the two sliders are fastened at two opposite sides of the moving plate respectively.

8. The shoe pattern imprinting mechanism according to claim 7, further comprising a control unit connected to the moving mechanism, the driving mechanism and the suction mechanism for controls thereof, the control unit provided to control movements of the sliders of the moving mechanism and the driving shaft of the driving mechanism, and the control unit further provided to control suction or stop of suction of the suction mechanism.

9. An imprinting method of the shoe pattern imprinting mechanism according to claim 1, comprising:
a film obtaining step, actuating the driving mechanism to allow the driving shaft to drive the flexible pressing ball to approach the imprinting film, the flexible pressing ball contacting the imprinting film, and actuating the suction mechanism to perform suction with the plurality of vent holes sucking the imprinting film;
a moving step, actuating the driving mechanism to allow the driving shaft to drive the flexible pressing ball and the imprinting film to move away from the carrier stand and the shoe body, forming a heating space between the carrier stand and the flexible pressing ball;
a heating step, actuating the heating unit to move to the heating space, the heating unit facing toward the flexible pressing ball and the imprinting film, the imprinting film having a hot melt layer, an imprinting layer and a release layer stacked on each other sequentially, the imprinting layer arranged further away from the heating unit in comparison to the hot melt layer, the heating unit heating the imprinting film until the hot melt layer reaching a molten state;
a retreat step, actuating the heating unit to move away from the heating space;
an imprinting step, actuating the driving shaft to drive the flexible pressing ball and the imprinting film to approach the shoe body until the imprinting film being attached to the shoe body, the imprinting film being imprinted onto a surface of the shoe body; and
a release step, removing the release film.

10. The imprinting method of the shoe pattern imprinting mechanism according to claim 9, wherein the heating unit includes a first heater and a second heater, the first heater heats the imprinting film, and the second heater heats the shoe body.

11. The imprinting method of the shoe pattern imprinting mechanism according to claim 10, wherein a heating temperature of the first heater heating the imprinting film is between 80° C. and 120° C., a heating temperature of the second heater heating the shoe body is between 50° C. and 80° C., a heating period of the first heater and the second heater is greater than or equal to 5 minutes and smaller than or equal to 30 minutes respectively.

12. The imprinting method of the shoe pattern imprinting mechanism according to claim 9, wherein a pressure of the flexible pressing ball pressing the imprinting film on the shoe body is greater than or equal to 0.1 kPa and smaller than or equal to 15 kPa; a pressing time of the flexible pressing ball pressing the imprinting film on the shoe body is greater than or equal to 5 minutes or smaller than or equal to 60 minutes.

13. The imprinting method of the shoe pattern imprinting mechanism according to claim 9, wherein the suction mechanism is actuated to perform suction and the driving mechanism is actuated to move away from the shoe body, allowing the release film to be driven and removed by the flexible pressing ball.
